(19) United States
(12) Patent Application Publication
(10) Pub. No.: US 2006/0233514 A1
(43) Pub. Date: Oct. 19, 2006

(54) System and method of video editing

(76) Inventors: Shih-Hsiung Weng, Taipei City (TW); Yen-Hwong Chong, Penang (MY)

Correspondence Address: RABIN & BERDO, P.C.;Suite 500, 1101 14 Street, N.W., Washington, DC, 20005, US

(21) Appl. No.: 11/105,447

(22) Filed: Apr. 14, 2005

(51) Int. Cl. H04N 5/91

(52) U.S. Cl. 386/46

(57) ABSTRACT

Disclosed is a system and method for editing video data through marking during video playing so that image retrieval and compiling can be easily made afterwards. During playing the video, the user commands at any position. The system gets the corresponding playing time and stores it as a mark. Then, in the editing operation, the system rapidly and precisely fetches the corresponding video clip according to the mark for replay and compiling so as to save time and improve efficiency.

### FIELD OF THE INVENTION

The invention generally relates to an image processing system and method, and in particular relates to a system and method of video editing.

### BACKGROUND OF THE INVENTION

Recently, home-use and public multimedia products are getting popular as video facilities and digital technologies being continuously improved and Internet being widely applied. Users can get image data from kinds of sources and store and retrieve them conveniently. However, the image data have to be processed for specific requirements. For example, the users want to compile their home videos into VCD or electronic albums, to publish to video networks, or even to select and store favorite programs from the television and to compile and retrieve them afterwards. People store video information more and more, the requirements of editing and retrieving also become more and more. When retrieving and editing video information, the user usually has to play the image from the start point by using fast-forward and fast-backward keys to search the required portion. This method is not precise for getting specific image clips. The search takes a long time as the search speed being limited, especially when searching a long video. The user usually requires trying several times to get the required video portion. Therefore, facing the recent plenty image contents, it is desired to have a search method that can mark the video image for later retrieval and editing so as to save user's time and to improve the searching precision.

### SUMMARY OF THE INVENTION

The object of the invention is to provide a system and method for editing video data through marking during video playing so that image retrieval and compiling can be easily made afterwards.

A video marking system for storing user-designated image position according to the invention includes a video databank for storing video files; an image playing module for getting and playing a video file from a start point; a time module for counting and displaying from the start point the playing time of the current image position; a mark-command module for receiving user's command of marking and getting the corresponding playing time of the current image position; and a mark storing module for storing the corresponding playing time.

The invention further provides a video editing system for compiling video clips according to the marks of image positions. The system includes a recall module for receiving user's command of recall and confirming the corresponding playing time of image; an image fetching module for fetching corresponding video clips according to the playing time; a command receiving module for receiving user's operation command; and an operation module for executing the user's command of video editing.

A video marking method for storing user-designated image position according to the invention includes steps of playing a video file; counting and displaying from the start point the playing time of the current image position; receiving user's command of marking and getting the corresponding playing time of the current image position; and storing the corresponding playing time.

The invention further provides a video editing method for compiling video clips according to the marks of image positions. The method includes steps of receiving user's command of recall and confirming the corresponding playing time of image; fetching a corresponding video clip according to the playing time; receiving user's operation command; and executing the user's command of video editing.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is schematic diagram of a video marking system of the invention;

FIG. 2 is a schematic diagram of a video editing system of the invention;

FIG. 3 is a flowchart of a video marking method of the invention; and

FIG. 4 is a flowchart of a video editing method of the invention.

### DETAILED DESCRIPTION OF THE INVENTION

The invention provides a system and method of video editing. User first designates marks on the playing video. The system then fetches the corresponding video clips according to the marks for required editing.

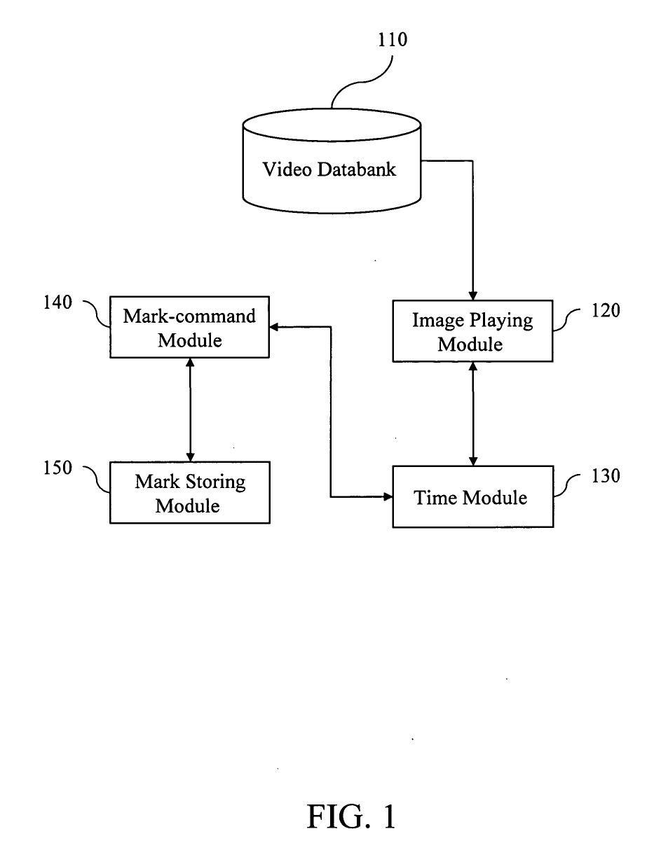

As shown in FIG. 1, a video marking system for storing user-designated image position according to the invention includes a video databank 110 for storing video files; an image playing module 120 for getting and playing a video file from a start point; a time module 130 for counting and displaying from the start point the playing time of the current image position; a mark-command module 140 for receiving user's command of marking and getting the corresponding playing time of the current image position; and a mark storing module 150 for storing the corresponding playing time. The details are described as follows.
1) The video databank 110 stores video files obtained from kinds of sources, such as recorded by camcorders, downloaded from websites or televisions.
2) The image playing module 120 gets a video file from the video databank 110 according to user's command, and plays the video file from a start point.
3) The time module 130 counts and displays from the start point the playing time of the current image position. The playing time is displayed in a format of “hour/minute/second”.
4) The mark-command module 140 receives user's command of marking and gets the corresponding playing time of the current image position when user inputs the marking command.
5) The mark storing module 150 stores the corresponding playing time of the user-designated image position.

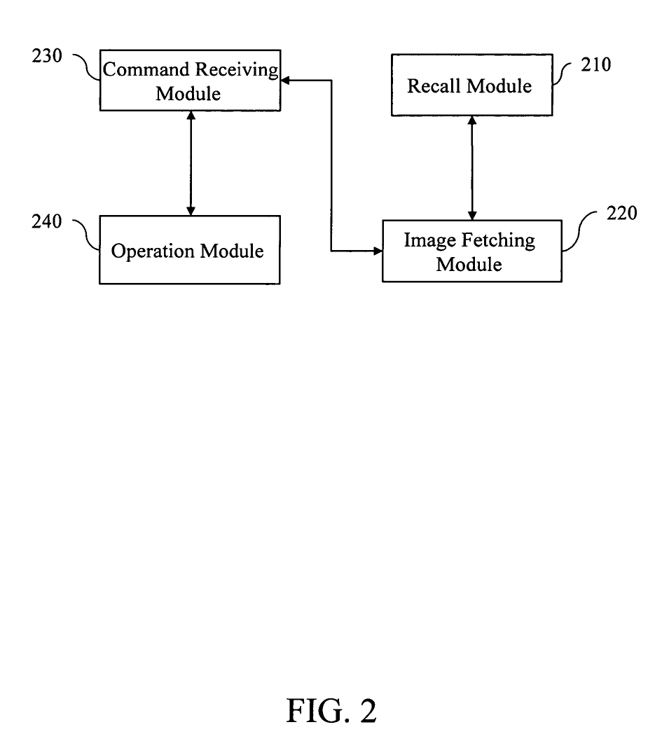

The invention further provides a video editing system for compiling video clips according to the marks of image positions. As shown in FIG. 2, the system includes a recall module 210 for receiving user's command of recall and confirming the corresponding playing time of image; an image fetching module 220 for fetching corresponding video clips according to the playing time; a command receiving module 230 for receiving user's operation command; and an operation module 240 for executing the user's command of video editing. The details are described as follows.
1) The recall module 210 receives user's command of recall and confirms the corresponding playing time of image to be recalled.
2) The image fetching module 220 fetches the corresponding video clips according to the playing time
3) The command receiving module 230 receives user's operation command, such as delete, replay, move, copy, paste and so on.
4) The operation module 240 executes the user's command of video editing. After deletion or moving, it also joints the rest parts.

A video marking and editing method of the invention applied through a multimedia viewer (MMV) is described below.

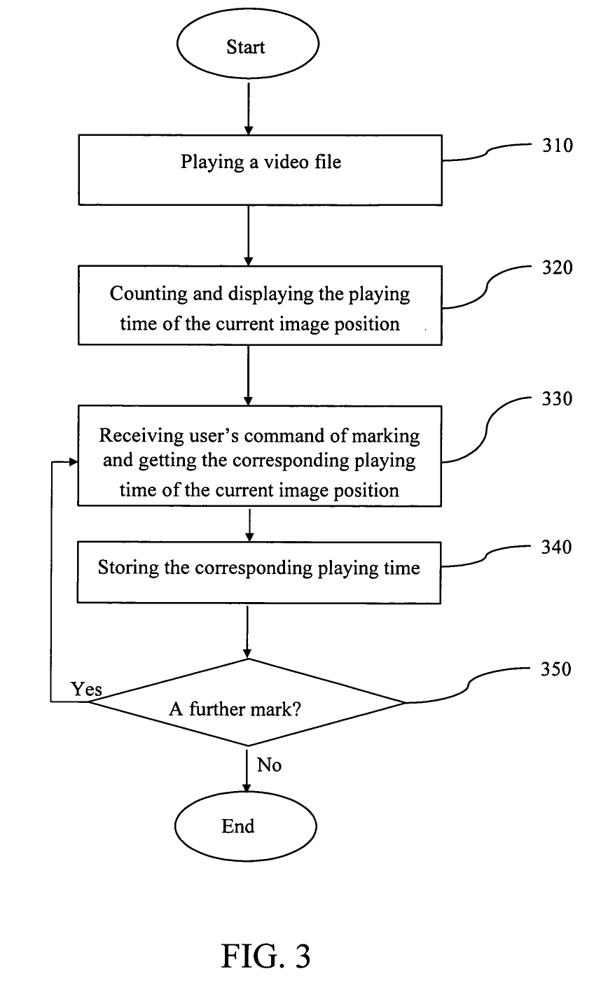

FIG. 3 is a flowchart of a video marking method for storing user-designated image position. The video file is taken from a storage device or a video/audio input, processed by a central processing unit and a video input processor, and displayed via a display unit. During the display, marks of corresponding image positions are designated by the user so that replay or editing of the video file can be easily made afterwards. First, playing the video file (step 310). Counting and displaying from the start point the playing time of the current image position (step 320). The playing time is displayed in a format of “hour/minute/second”. The user presses a “mark” button to designate the video position during viewing the video. The system receives user's command of marking, gets the corresponding playing time of the current image position (step 330) and stores the corresponding playing time (step 340). The video playing is continued for the user to make further marks. When the user wants a further mark (step 350), he or she presses the “mark” button to return the process to the step 330. The video portion between two marks is that to be fetched. If there is only one mark in the video file, i.e., the user only presses one time during the viewing, then the video content from the mark to the end of the file is fetched.

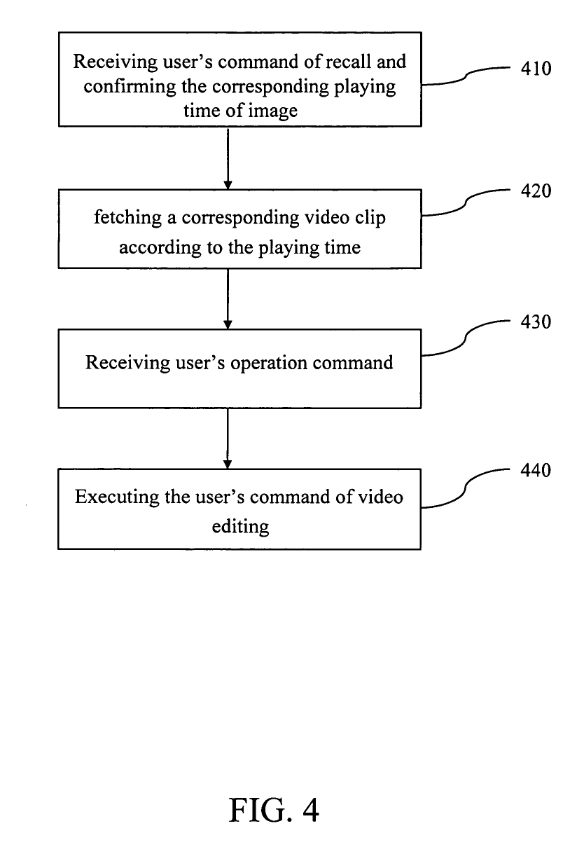

After the video marking, the user can easily recall the video clips for further editing. FIG. 4 is a flowchart of a video editing method of the invention. The video editing method compiles video clips according to the marks of image positions. The method includes steps of receiving user's command of recall and confirming the corresponding playing time of image (step 410). Then, fetching a corresponding video clip according to the playing time (step 420); receiving user's operation command (such as delete, replay, move, copy, paste and so on) (step 430); and executing the user's command of video editing (step 440). After deletion or moving, it also joints the rest parts.

The invention being thus described, it will be obvious that the same may be varied in many ways. Such variations are not to be regarded as a departure from the spirit and scope of the invention, and all such modifications as would be obvious to on e skilled in the art are intended to be included within the scope of the following claims.

What is claimed is:

1. A video marking system for storing user-designated image position, comprising:
a video databank for storing video files;
an image playing module for getting and playing a video file from a start point;
a time module for counting and displaying from said start point the playing time of current image position;
a mark-command module for receiving user's command of marking and getting a corresponding playing time of said current image position; and
a mark storing module for storing said corresponding playing time.

2. The video marking system according to claim 1 wherein said image playing module gets a video file from said video databank according to user's command.

3. A video editing system for compiling video clips according to marks of image positions, comprising:
a recall module for receiving an user's command of recall and confirming a corresponding playing time of image;
an image fetching module for fetching corresponding video clips according to said playing time;
a command receiving module for receiving user's operation command; and
an operation module for executing said user's command of video editing.

4. The video editing system according to claim 3 wherein said user's operation command comprises at least one of delete, replay, move, copy and paste.

5. The video editing system according to claim 4 wherein after one command of said delete and move, a joining of rest video clips is executed.

6. A video marking method for storing user-designated image position, comprising steps of:
playing a video file;
counting and displaying from a start point the playing time of current image position;
receiving user's command of marking and getting a corresponding playing time of said current image position; and
storing said corresponding playing time.

7. A video editing method for compiling video clips according to marks of image positions, comprising steps of:
receiving user's command of recall and confirming a corresponding playing time of image;
fetching a corresponding video clip according to said playing time;
receiving user's operation command; and
executing said user's command of-video editing.

8. The video editing method according to claim 7 wherein said step of fetching a corresponding video clip according to playing time is to fetch a video clip from a mark to the end of said video file when there is only one mark in said file.

9. The video editing method according to claim 7 wherein said user's operation command comprises at least one of delete, replay, move, copy and paste.

10. The video editing method according to claim 9 wherein after one command of said delete and move, a joining of rest video clips is executed.
